(19) United States
(12) Patent Application Publication
(10) Pub. No.: US 2005/0135692 A1
(43) Pub. Date: Jun. 23, 2005

(54) Zero coding

(76) Inventors: Kumar S. Golla, Plano, TX (US); David K. Vavro, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/742,118

(22) Filed: Dec. 19, 2003

(51) Int. Cl. G06K 9/36

(52) U.S. Cl. 382/248

(57) ABSTRACT

Embodiments of the invention provide a method and apparatus for zero coding to provide an instruction to generate context values for a selected coefficient bit. In particular, horizontal, vertical and diagonal neighbors of the selected coefficient bit are computed and a context value generated in response to the computed values. The number of immediate horizontal, vertical and diagonal neighbors in which the significance value is a first state, such as one, is determined.

### RELATED APPLICATIONS

This application is related to U.S. application serial no. ______, filed on ______, entitled “Bit-Plane Formatting Including Zero Bit-Plane Detection”; U.S. application serial no. ______, filed on ______, entitled “Magnitude Refinement Coding”; U.S. application serial no. ______, filed on ______, entitled “Run Length Coding and Decoding”; U.S. application serial no. ______, filed on ______, entitled “Sign Coding and Decoding”; and U.S. application serial no. ______, filed on ______, entitled “Zero Coding or Run Length Coding Decision.”

### BACKGROUND

The JPEG 2000 standard utilizes transforms and provides a coding scheme and code stream definition for images. (See JPEG2000 standard, Information Technology—JPEG 2000 Image Coding System: Core Coding System, ISO/IEC FDIS 15444-1: 2000 JPEG Image Coding System, incorporated herein by reference.) Under the JPEG 2000 Standard, each image may be divided into rectangular tiles. If there is more than one tile, the tiling of the image creates tile-components. After tiling of an image, the tile-components are decomposed into one or more different decomposition levels using a wavelet transformation. These decomposition levels contain a number of sub-bands populated with coefficients that describe the horizontal and vertical spatial frequency characteristics of the original tile-components. The coefficients provide frequency information about a local area, rather than across the entire image. In particular, a small number of coefficients completely describe a single sample.

In JPEG2000, the arithmetic coding and decoding is performed bit-plane by bit-plane, from the most significant bit plane to the least significant bit plane. This reveals a weak point in processors, as they are not efficient when operating in the bit plane level in 2D.

### BRIEF DESCRIPTION OF THE DRAWINGS

FIG. 1 illustrates a block diagram of one embodiment of a coder embodying the invention.

FIG. 2 illustrates a block diagram of one embodiment of a DWT decomposing an original image into subbands.

FIG. 3 illustrates a diagram of an exemplary embodiment of a code-block scan pattern of a code-block.

FIG. 4 illustrates a block diagram of one embodiment of registers for storing values for significance state variables sigma.

FIG. 5 is an embodiment of a system for implementing embodiments of the invention.

FIG. 6 is a flowchart of an embodiment for zero coding.

### DETAILED DESCRIPTION

The principles of the arrangement described herein have general applicability to coding symbols representative of transform coefficients of one or more blocks of a digital image. For ease of explanation, the preferred embodiment is described with reference to JPEG2000. However, it is not intended that the present invention be limited to the described arrangement. For example, the invention may have application to bit-plane coding techniques in general and other coding techniques.

In JPEG2000, discrete wavelet transform coefficient bits are arranged into code-blocks and coded in bit plane order using three coding passes for each bit plane. A code-block is defined as a rectangular block within a sub-band. The coefficients inside the code-block are coded a bit plane at a time, starting with the most significant bit plane having a non-zero element and ending with the least significant bit plane.

For each bit plane in a code-block, a particular code-block scan pattern is used for each significance propagation, magnitude refinement and cleanup pass. Each coefficient bit is coded only once in one of the three passes. The pass in which a coefficient bit is coded depends on the conditions for that pass. For each pass, contexts are created using the significance states of neighboring coefficient bits of the coefficient bit currently being coded. The context is passed to an arithmetic coder along with the bit stream to effect entropy coding.

Embodiments of the invention provide a method and apparatus for zero coding to provide an instruction to generate context values for a selected coefficient bit. In particular, horizontal, vertical and diagonal neighbors of the selected coefficient bit are computed and a context value generated in response to the computed values. The number of immediate horizontal, vertical and diagonal neighbors in which the significance value is a first state, such as one, is determined.

In the detailed description, numerous specific details are set forth in order to provide a thorough understanding of the present invention. However, it will be understood by those skilled in the art that the present invention may be practiced without these specific details. In other instances, well-known methods, procedures, components and circuits have been described in detail so as not to obscure the present invention.

Some portions of the detailed description that follow are presented in terms of algorithms and symbolic representations of operations on data bits or binary signals within a computer. These algorithmic descriptions and representations are the means used by those skilled in the data processing arts to convey the substance of their work to others skilled in the art. An algorithm is here, and generally, considered to be a self-consistent sequence of steps leading to a desired result. The steps include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities. Unless specifically stated otherwise as apparent from the following discussions, it is appreciated that throughout the specification, discussions utilizing such terms as “processing” or “computing” or “calculating” or “determining” or the like, refer to the action and processes of a computer or computing system, or similar electronic computing device, that manipulate and transform data represented as physical (electronic) quantities within the computing system's registers and/or memories into other data similarly represented as physical quantities within the computing system's memories, registers or other such information storage, transmission or display devices.

Embodiments of the present invention may be implemented in hardware or software (microcode), or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a micro-controller, an application specific integrated circuit (ASIC), or a microprocessor.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

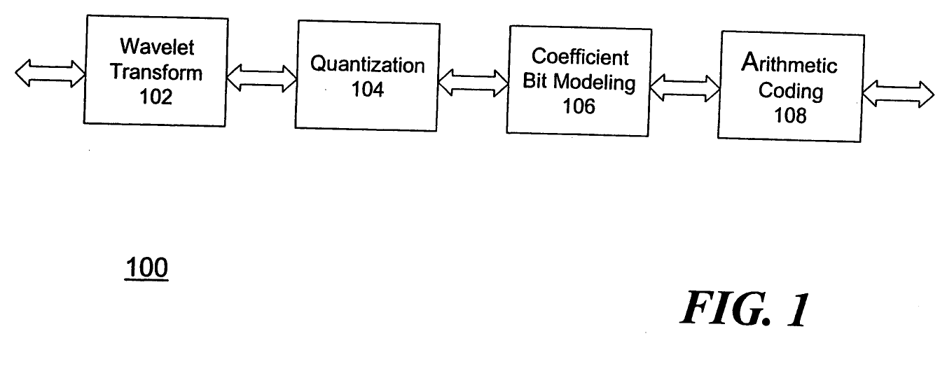

Before proceeding with a description of the preferred arrangement, a brief review of the JPEG2000 coding method is given. Referring to FIG. 1, a block diagram of one embodiment 100 of a coder embodying the invention is illustrated. As mentioned previously, JPEG2000 divides a whole image into one or more image tile components, each of which are then 2-D discrete wavelet transformed. The transform coefficients of each image tile component are then grouped into sub-bands, which sub-bands are further partitioned into rectangular code blocks before each code block is then entropy encoded.

In particular, embodiment 100 of coder includes a discrete wavelet transform (DWT) 102, quantizer 104, coefficient bit modeler 106 and entropy coder 108 suitable for compressing images in accordance with JPEG2000. The original image is first divided into tiles. These tiles are rectangular arrays that include the same relative portion of all the components that make up the image. Thus, tiling of the image actually creates tile-components that can be decoded independently of each other. These tile-components can also be extracted and reconstructed independently. This tile independence provides one of the methods for extracting a region of the image.

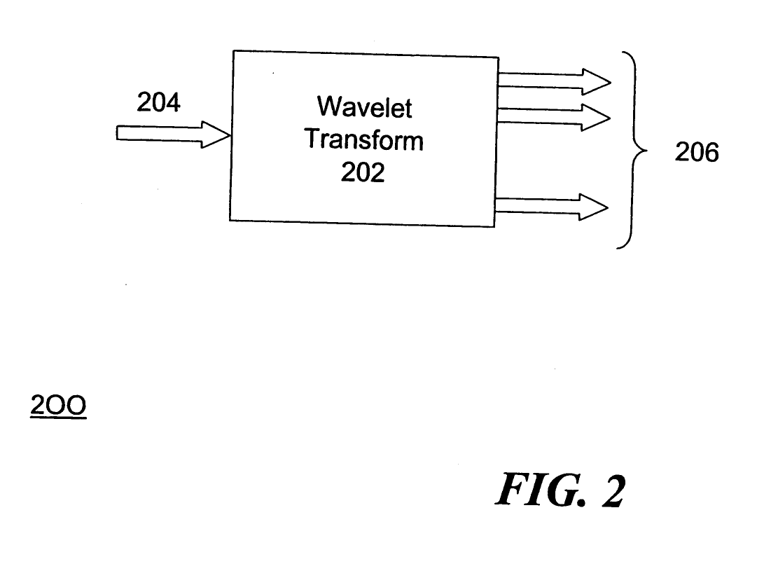

FIG. 2 illustrates a block diagram of one embodiment 200 of a DWT 202 decomposing an original image 204 into subbands 206. The tile components are decomposed into different decomposition levels using a wavelet transform. These decomposition levels contain a number of sub-bands populated with coefficients that describe the horizontal and vertical spatial frequency characteristics of the original tile-component planes. The coefficients provide frequency information about a local area, rather than across the entire image. That is, a small number of coefficients completely describe a single sample. A decomposition level is related to the next decomposition level by spatial powers of two. That is, each successive decomposition level of the sub-bands has approximately half the horizontal and half the vertical resolution of the previous. Images of lower resolution than the original are generated by decoding a selected subset of these sub-bands.

For example, a first DWT stage decomposes the original image (LL₀) into four sub-bands, denoted by the labels LL₁, HL₁, LH₁, and HH₁. The labels indicate the filtering and decomposition level (LL₁=low-pass filtering horizontally, low-pass filtering vertically, at the 1st level of decomposition). These sub-bands are populated with wavelet coefficients that describe spatial frequency characteristics of the original image. The second stage further breaks down LL, into the four sub-bands LL₂, HL₂, LH₂, and HH₂. Although only three such stages are shown in FIG. 2, this process may continue for many stages. Each LLn sub-band is a reasonable low resolution rendition of LLₙ₋₁ with half the width and height.

Although there are as many coefficients as there are samples, the information content tends to be concentrated in just a few coefficients. Through quantization 104, the information content of a large number of small magnitude coefficients is further reduced. Additional processing by the entropy encoder reduces the number of bits required to represent these quantized coefficients, sometimes significantly compared to the original image.

The individual sub-bands of a tile-component are further divided into code-blocks. These rectangular arrays of coefficients can be extracted independently. In particular, each sub-band, comprised of coefficients produced in the DWT, is subjected to uniform scalar quantization in the quantization step. The quantized coefficients of the sub-bands are further broken down into two-dimensional arrays (for example, 64×64 or 32×32 samples) called code-blocks.

The coefficients are associated with different sub-bands arising from the transform applied. These coefficients are then arranged into rectangular blocks with each sub-band, called code-blocks. These code-blocks are then coded a bit-plane at a time starting from the most significant bit-plane with a non-zero element to the least significant bit-plane.

For each bit-plane in a code-block, a special code-block scan pattern is used for each of the coding passes. Each coefficient bit in the bit-plane is coded in only one the three coding passes. The coding passes are called significance propagation, magnitude refinement, and cleanup. For each pass, contexts are created which are provided to the arithmetic coder, CX, along with the bit stream, CD. The arithmetic coding step uses the context vectors and the corresponding coefficients to create a compressed data stream. The arithmetic coder is reset according to selected rules.

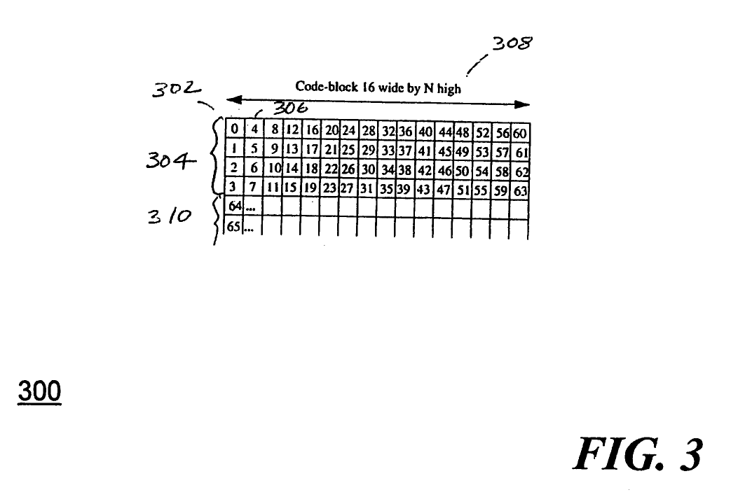

As stated above, the code-blocks of quantized coefficients are coded with three coding passes. These coding passes are performed on “bit planes,” each of which is an array consisting of bits taken from the same position in each coefficient. The first bit plane is comprised of the most significant bits (MSB) of all the coefficient magnitudes in the code-block. The second bit-plane is comprised of the second MSBs of all the coefficient magnitudes in the code-block, and so on. Referring to FIG. 3, each quantized coefficient has four bits, for example, a₁, a₂, a₃, a₄. The MSB of each coefficient has a subscript of “1,” for example, a₁. The first bit plane is comprised of a₁, b₁, c₁, d₁, the second bit-plane is comprised of a₂, b₂, c₂, d₂ and so forth until the least significant bits (LSB).

FIG. 3 is a diagram of an exemplary embodiment 300 of a code-block scan pattern of a code-block. Each bit-plane is scanned in a particular order. Starting at the top left 302, the first four bits of the first column 304 are scanned. Then the first four bits of the second column 306, until the width 308 of the code-block has been covered. Then the second four bits 310 of the first column are scanned and so on. A similar vertical scan is continued for any leftover rows on the lowest code-blocks in the sub-band.

This scan pattern is followed in each of the three coding passes. The decision as to in which pass a given bit is coded is made based on the “significance” of that bit's location and the significance of neighboring locations. A location is considered significant if a 1 has been coded for that location (quantized coefficient) in the current or previous bit planes.

The first pass is called the significance propagation pass. A bit is coded in this pass if its location is not significant, but at least one of its eight-connected neighbors is significant. If a bit is coded in this pass, and the value of that bit is “1,” its location is marked as significant for the purpose of coding subsequent bits in the current and subsequent bit planes. Also, the sign bit is coded immediately after the “1” bit just coded.

The second pass is the magnitude refinement pass (MRP), where all bits from the locations that became significant in a previous bit plane are coded.

The third and final pass is the clean-up pass, where bits not coded in the first two passes are taken care of. The results of these three scanning passes are the context vectors for the quantized coefficients.

In general, a current coefficient can have 256 possible context vectors. These are clustered into a smaller number of contexts according to the rules specified below for context information. Four different context formulation rules are defined, one for each of the four coding operations: significance coding, sign coding, magnitude refinement coding and cleanup coding. These coding operations are performed in three coding passes over each bit plane: significance and sign coding in a significant propagation pass, magnitude refinement coding in a magnitude refinement pass, and cleanup and sign coding in a cleanup pass. For a given coding operation, the context label (or context) provided to the arithmetic coding engine is a label assigned to the current coefficient's context.

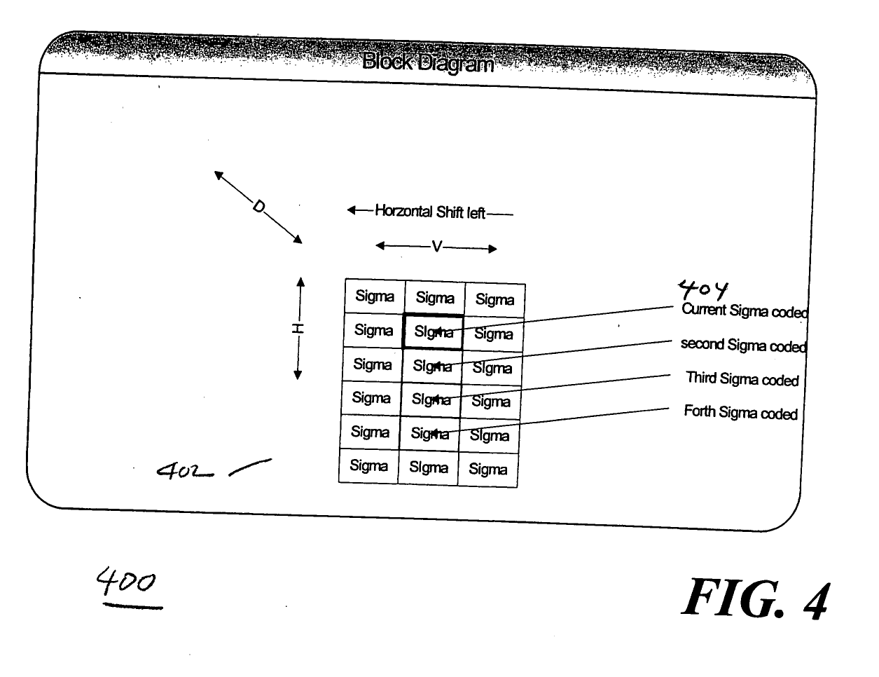

FIG. 4 illustrates a block diagram of one embodiment 400 of registers 402 for storing values for significance state variables sigma. In accordance with embodiments of the invention, when encoding and decoding bit planes, zero coding/decoding may occur in the clean up pass and the significant propagation pass. This decision is based upon the bit state variables sigma being zero. When performing zero coding, the sigmas are used to determine the output context (CX).

The array of state variable sigmas corresponds to an array of quantized coefficients being scanned. Each bit-plane of a code block is scanned in a particular order. Starting at the top left, the first four bit symbols of the column are scanned. Then the first four bit symbols of the second column, until the width of the code-block has been covered. Then the second four bit symbols of the first column are scanned and so on. A similar scan is continued for any leftover rows on the lowest code blocks in the sub-band. Sigma bits are typically stored in local processors registers in the same scan order as shown in FIG. 4. These can be shifted to the left to perform the same compare on the next scan.

For illustrative purposes, embodiments of the zero coding instruction will center on coefficient bit 404 in bold and the surrounding neighbors. In the code segment, the state variable of the quantized coefficient being currently scanned is located at 404. Embodiments of the instruction will compute the following quantities (h,v,d) based on the horizontal neighbors, vertical neighbors, and diagonal neighbors of the selected coefficient bit (such as bit 404) as follows:
1. h=the number of immediate horizontal neighbors in which Sigma is 1.
2. v=the number of immediate vertical neighbors in which Sigma is 1.
3. d==the number of immediate diagonal neighbors in which Sigma is 1.

Referring to TABLE 1, based upon these quantities and the current wavelet subband being processed the following output (CX) is placed into the destination register along with the current bit value being coded (X=do not care).

TABLE 1

| LL and LH Subbands | | | | HL Subbands | | | | HH Subbands | | |
|---|---|---|---|---|---|---|---|---|---|---|
| h | v | d | CX | h | v | d | CX | d | h + v | CX |
| 2 | x | X | 8 | X | 2 | X | 8 | >=3 | x | 8 |
| 1 | >=1 | X | 7 | >=1 | 1 | X | 7 | 2 | >=1 | 7 |
| 1 | 0 | >=1 | 6 | 0 | 1 | >=1 | 6 | 1 | 0 | 6 |
| 1 | 0 | 0 | 5 | 0 | 1 | 0 | 5 | 1 | >=2 | 5 |
| 0 | 2 | X | 4 | 2 | 0 | X | 4 | 1 | 1 | 4 |
| 0 | 1 | X | 3 | 1 | 0 | X | 3 | 0 | 0 | 3 |
| 0 | 0 | >=2 | 2 | 0 | 0 | >=2 | 2 | 0 | >=2 | 2 |
| 0 | 0 | 1 | 1 | 0 | 0 | 1 | 1 | 0 | 1 | 1 |
| 0 | 0 | 0 | 0 | 0 | 0 | 0 | 0 | 0 | 0 | 0 |

The h and v columns are reversed between (LL and LH) and (HL) subbands. The instruction also specifies which current bit location is being coded from 1 to 4 locations horizontally in FIG. 4. This is because not only the current bit value will be placed in the destination register with CX but the current sigma in bold can move from the current location in FIG. 4 down to 3 sigma locations. As previously noted, each bit-plane is scanned in a particular order. For example, the first four bits 404-410 of the column are scanned. In the code segment, the state variable of the quantized coefficient being currently scanned is located at 404. The input starts at the current coefficient bit coded in bold 404 and includes the next three bits down as input. The bits are the bit-plane of the coefficients of a code block.

In a typical implementation, if a processor used a look up table to compute the CX values based on h, v, and d it would still have to calculate h, v, and d. To calculate h would require 2 reads with AND to mask out one horizontal bit and then 1 instruction to add the results. To calculate v would also require 2 reads with AND to mask out one vertical bit and then 1 instruction to add the results. To calculate the d would require 4 reads with ANDs to mask out the diagonal bits and 3 add instruction. The total number is 13 instructions to calculate v, h, and d with 1 instruction for table look up. Also 1 instruction is needed to read and mask out the current bit value, and 1 instruction to pack both CX and current bit value. The total being 16 instructions needed to perform zero coding with standard instructions versus 1 instruction as the invention described.

To code a 64×64 pixel block with 16 bits, the zero coding can be performed once in each bit plane. Assuming that the average time zero coding is performed is 25% of the time in each bit case, the total times that zero coding might occur is 64×64×16×0.25=13107. Thus, with the addition of this instruction to a processor performing JPEG2000 would save 15×13107=196605 instructions for just a 64×64 pixel block.

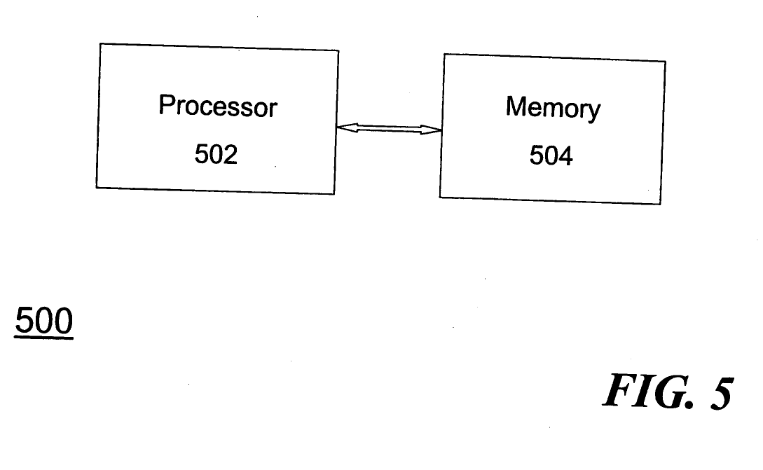

FIG. 5 is an embodiment of a system 500 for implementing embodiments of the invention. In particular, the system includes a processor 502 and memory 504. As noted above, for purposes of this application, a processing system includes any system that has a processor, such as, for example, a digital signal processor (DSP), a micro-controller, an application specific integrated circuit (ASIC), or a microprocessor. The system may be specially constructed for the required purposes, or it may comprise a general purpose computer selectively activated or reconfigured by a computer program stored in the computer. The processor 502 may be configured to format images compatible with the JPEG2000 format. During encoding, the processor 502 applies one or more wavelet transforms to generate a plurality of coefficients. In response to selected coefficient bits to be processed, the processor 502 executes an instruction stored in memory for zero coding as described herein.

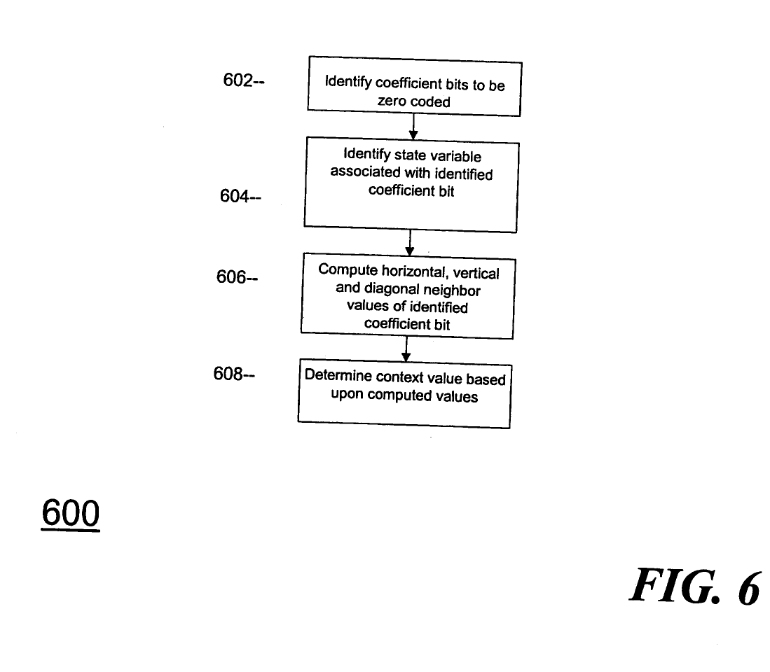

FIG. 6 is a flowchart 600 of an embodiment for zero coding.

In step 602, a coefficient bit to be zero coded is selected.

In response to the selected coefficient bit to be processed (step 602), a state variable associated with the selected coefficient bit to be processed is received (step 604).

In step 606, the horizontal, vertical and diagonal neighbors of the selected coefficient bit is computed. The number of immediate horizontal, vertical and diagonal neighbors in which the significance value is a first state, such as one, is determined.

In step 608, a context value in response to the computed values is generated.

The advantages of this invention allow a signal processor or a general processor to perform a vital piece of JP2000 bit plane coding and decoding at a much higher rate. If this instruction is included in the instruction set, the processor has a greater advantage than without one when supporting JPEG2000.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. Embodiments of the invention may be implemented in digital signal processors as well as standard processors because of the capabilities it provides for processing applications such as JPEG2000 as well as existing applications such as JPEG. These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method for zero coding, comprising:
selecting a coefficient bit to be zero coded;
in response to the selected coefficient bit to be processed, executing an instruction to generate context values for the selected coefficient bit, comprising:
receiving a state variable associated with the selected coefficient bit to be processed;
computing horizontal, vertical and diagonal neighbors of the selected coefficient bit; and
generating a context value in response to the computed values

2. The method claimed in claim 1, wherein computing horizontal, vertical and diagonal neighbors of the selected coefficient bit
determining the number of immediate horizontal neighbors in which the significance value is a first state.

3. The method claimed in claim 2, wherein computing horizontal, vertical and diagonal neighbors of the selected coefficient bit
determining the number of immediate vertical neighbors in which the significance value is a first state.

4. The method claimed in claim 3, wherein computing horizontal, vertical and diagonal neighbors of the selected coefficient bit
determining the number of immediate diagonal neighbors in which the significance value is a first state.

5. The method claimed in claim 4, wherein the first state has a value of one.

6. The method claimed in claim 5, wherein the state variable is a sigma value in accordance with JPEG2000.

7. The method claimed in claim 1, further comprising:
executing the instruction to generate context values for the next three bits scanned down vertically associated with the selected coefficient bit.

8. The method claimed in claim 7, wherein executing the instruction to generate context values for the next three bits scanned down vertically associated with the selected coefficient bit further comprises:
receiving state variables associated with bit-planes being scanned in a particular order.

9. A system, comprising:
a memory;
a processor to execute an instruction to
compute horizontal, vertical and diagonal neighbors of the selected coefficient bit; and
generate a context value in response to the computed values

10. The system claimed in claim 10, wherein to compute horizontal, vertical and diagonal neighbors of the selected coefficient bit, the number of immediate horizontal neighbors in which the significance value is a first state is determined.

11. The system claimed in claim 10, wherein to compute horizontal, vertical and diagonal neighbors of the selected coefficient bit, the number of immediate vertical neighbors in which the significance value is a first state is determined.

12. The system claimed in claim 11, wherein to compute horizontal, vertical and diagonal neighbors of the selected coefficient bit, the number of immediate diagonal neighbors in which the significance value is a first state is determined.

13. The system claimed in claim 12, wherein the first state has a value of one.

14. The system claimed in claim 1, wherein the state variable is a sigma value in accordance with JPEG2000.

15. The system claimed in claim 1, further comprising an instruction to generate context values for the next three bits scanned down vertically associated with the selected coefficient bit.

16. A machine readable medium having stored therein a plurality of machine readable instructions executable by a processor to zero code, comprising:
instructions to selecting a coefficient bit to be zero coded;
instructions to receiving a state variable associated with the selected coefficient bit to be processed;
instructions to computing horizontal, vertical and diagonal neighbors of the selected coefficient bit; and
instructions to generating a context value in response to the computed values

17. The machine readable medium claimed in claim 16, wherein instructions to computing horizontal, vertical and diagonal neighbors of the selected coefficient bit
instructions to determining the number of immediate horizontal neighbors in which the significance value is a first state.

18. The machine readable medium claimed in claim 17, wherein instructions to computing horizontal, vertical and diagonal neighbors of the selected coefficient bit
instructions to determining the number of immediate vertical neighbors in which the significance value is a first state.

19. The machine readable medium method in claim 18, wherein instructions to computing horizontal, vertical and diagonal neighbors of the selected coefficient bit
instructions to determining the number of immediate diagonal neighbors in which the significance value is a first state.

20. The machine readable medium claimed in claim 19, wherein the first state has a value of one.

21. The machine readable medium claimed in claim 16, wherein the state variable is a sigma value in accordance with JPEG2000.

22. The machine readable medium claimed in claim 16, further comprising:
instructions to executing the instruction to generate context values for the next three bits scanned down vertically associated with the selected coefficient bit.

23. The machine readable medium claimed in claim 22, wherein instructions to generate context values for the next three bits scanned down vertically associated with the selected coefficient bit further comprises:
instructions to receive state variables associated with bit-planes being scanned in a particular order.
